(19) United States
(12) Patent Application Publication
(10) Pub. No.: US 2025/0379506 A1
(43) Pub. Date: Dec. 11, 2025

(54) SEMICONDUCTOR DEVICE

(71) Applicant: ROHM Co., LTD., Kyoto (JP)

(72) Inventor: Shingo Hashiguchi, Kyoto (JP)

(21) Appl. No.: 19/199,915

(22) Filed: May 6, 2025

(30) Foreign Application Priority Data
Jun. 7, 2024 (JP) 2024-093086

(51) Int. Cl. H02M 1/088; H02M 3/158

(52) U.S. Cl. CPC H02M 1/088; H02M 3/158

(57) ABSTRACT

Provided is a semiconductor device including a drive voltage generation circuit configured to generate a drive voltage on the basis of a first external resistor externally attached to a first external terminal, a first signal generation circuit configured to generate a first clock signal for pulse driving based on the drive voltage and a second external resistor externally attached to a second external terminal, a second signal generation circuit configured to generate a second clock signal for pulse driving based on an internal resistor and the drive voltage, a count circuit configured to generate a count signal according to a count value obtained by counting pulses of the first clock signal in a determination section while counting the determination section according to pulses of the second clock signal, and a multifunction output circuit configured to output an output signal of an output value that differs depending on the count signal.

### CROSS REFERENCE TO RELATED APPLICATIONS

This application claims priority benefit of Japanese Patent Application No. JP 2024-093086 filed in the Japan Patent Office on Jun. 7, 2024. Each of the above-referenced applications is hereby incorporated herein by reference in its entirety.

### BACKGROUND

A technology disclosed in the present specification relates to a semiconductor device and a power supply device.

Hitherto, there has been known a power supply device (e.g., a direct current to direct current (DC/DC) converter) that changes a voltage on the basis of a clock signal generated by an oscillation circuit.

Examples of the related art concerning such a power supply device include one disclosed in Japanese Patent Laid-open No. 2022-112806.

### BRIEF DESCRIPTION OF THE DRAWINGS

FIG. 1 is a block diagram depicting a configuration of a power supply device 1;

FIG. 2 is a diagram depicting a configuration of an oscillation circuit 19;

FIG. 3 is a block diagram depicting a configuration of a semiconductor device 40;

FIG. 4 is a timing chart depicting pulses of a first clock signal CLKb and a second clock signal CLKc;

FIG. 5 is a timing chart depicting the first clock signal CLKb in a case in which a second external resistor R6 is changed to a resistor with a different resistance value;

FIG. 6 is a table indicating a relation between a resistance value of the second external resistor R6, a count value n2, and a voltage value of a second output voltage Vo2; and

FIG. 7 is a diagram depicting a modification of the semiconductor device 40 according to an embodiment of the present disclosure.

### DETAILED DESCRIPTION

### <Power Supply Device 1>

First, an overall configuration of a power supply device 1 according to an embodiment of the present disclosure is described.

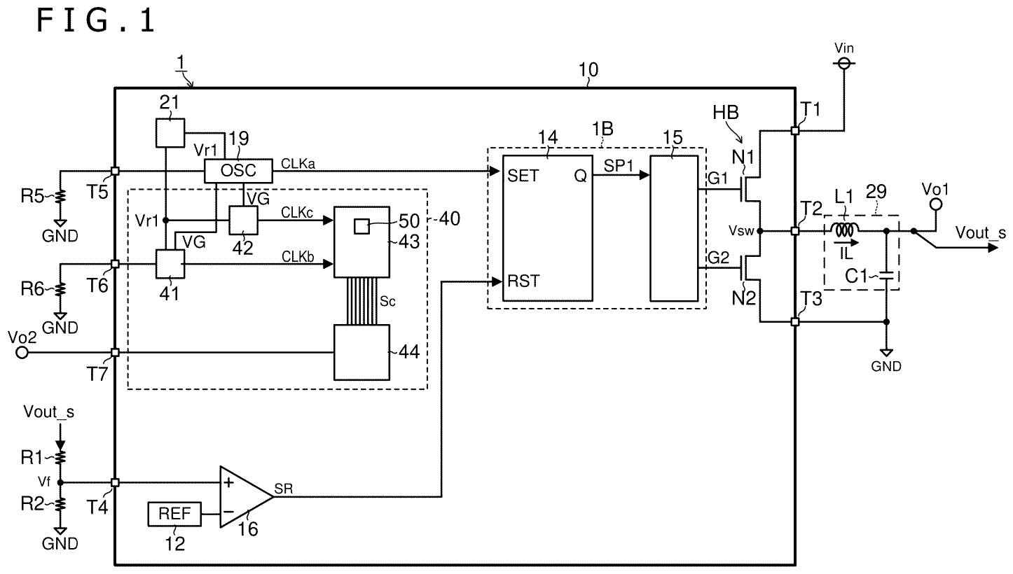

FIG. 1 is a block diagram depicting a configuration of the power supply device 1. As depicted in FIG. 1, the power supply device 1 is a buck DC/DC converter that generates a first output voltage Vo1 from an input voltage Vin and supplies the first output voltage Vo1 to a load (not depicted). Further, the power supply device 1 outputs a second output voltage Vo2. Details of the second output voltage Vo2 will be described later.

The power supply device 1 has a power supply control device 10 and various discrete components (e.g., an inductor L1, a capacitor C1, and resistors R1 and R2).

### <Power Supply Control Device 10>

The power supply control device 10 is a semiconductor integrated circuit (IC) device (what is called a power supply control IC). The power supply control device 10 includes external terminals T1 to T7 as terminals for establishing electrical connection to the outside of the device.

The external terminal T1 is connected to an input terminal of the input voltage Vin. The external terminal T2 is connected to a first end of the inductor L1. A second end of the inductor L1 is connected to an output terminal of the first output voltage Vo1 together with a first end of the capacitor C1. The external terminal T3 is connected to a ground terminal GND. A second end of the capacitor C1 is connected to the ground terminal GND. Hereinafter, a potential applied to the ground terminal GND is sometimes referred to as a ground voltage GND (=0 V).

The external terminal T4 receives input of a feedback voltage Vf based on the first output voltage Vo1. The external terminal T5 is connected to a first end of a first external resistor R5. The external terminal T6 is connected to a first end of a second external resistor R6. A second end of each of the first external resistor R5 and the second external resistor R6 is connected to the ground terminal GND. The external terminal T7 outputs the second output voltage Vo2 to be described later.

The power supply control device 10 has a switch output stage HB, a comparison voltage generation circuit 12, a reset signal generation circuit 16, a first reference voltage generation circuit 21, an oscillation circuit 19, a driver stage 1B, and a semiconductor device 40.

The switch output stage HB is a half-bridge output stage including an output element N1 and a rectifier element N2. Each of the output element N1 and the rectifier element N2 is an N-channel metal-oxide-semiconductor field-effect transistor (MOSFET). Switching driving of the output element N1 and the rectifier element N2 is complementarily executed according to drive signals G1 and G2. The term “complementarily” used herein should be interpreted in a broad sense to include not only a case in which the on/off-states of the output element N1 and the rectifier element N2 are completely inverted but also a case in which a period during which both simultaneously enter the off-state (what is called a dead time) is set.

The drain of the output element N1 is connected to the external terminal T1. The source of the output element N1 and the drain of the rectifier element N2 are both connected to the external terminal T2. The source of the rectifier element N2 is connected to the external terminal T3. The gate of the output element N1 and the gate of the rectifier element N2 are connected to an application terminal of the drive signal G1 and an application terminal of the drive signal G2, respectively.

When the drive signal G1 is at a high level and the drive signal G2 is at a low level, the output element N1 is turned on, and the rectifier element N2 is turned off. Then, a current flows in a path that reaches the external terminal T2 from the external terminal T1 through the output element N1, and electrical energy is stored in the inductor L1.

On the other hand, when the drive signal G1 is at the low level and the drive signal G2 is at the high level, the output element N1 is turned off, and the rectifier element N2 is turned on. Then, a current flows in a path that reaches the external terminal T2 from the external terminal T3 through the rectifier element N2, until the electrical energy stored in the inductor L1 becomes depleted.

Through repetition of such switching driving, a switch voltage Vsw with a rectangular wave shape appears at the external terminal T2. The first output voltage Vo1 as a DC voltage can be obtained by smoothing the switch voltage Vsw with the use of a smoothing rectifier circuit 29 configured by the capacitor C1 and the inductor L1.

A first end of the resistor R1 is connected to the output terminal of the first output voltage Vo1. A second end of the resistor R1 is connected to the external terminal T4 together with a first end of the resistor R2. A second end of the resistor R2 is connected to the ground terminal GND. That is, the first output voltage Vo1 is fed back and input to the external terminal T4 through the resistor R1.

The resistor R1 and the resistor R2 form a voltage divider circuit. Specifically, the feedback voltage Vf is generated at a connection node between the resistor R1 and the resistor R2. The feedback voltage Vf is determined by the first output voltage Vo1 (in FIG. 1, represented as Vout_s) and a voltage division ratio that is determined by a resistance value of each of the resistor R1 and the resistor R2.

The comparison voltage generation circuit 12 is configured to generate a comparison voltage REF that is a predetermined constant voltage.

The reset signal generation circuit 16 is a comparator. The reset signal generation circuit 16 has an inverting input terminal (−) and a non-inverting input terminal (+). The inverting input terminal (−) of the reset signal generation circuit 16 is connected to the comparison voltage generation circuit 12. The non-inverting input terminal (+) of the reset signal generation circuit 16 is connected to the external terminal T4.

The feedback voltage Vf is input to the non-inverting input terminal (+) of the reset signal generation circuit 16. The comparison voltage REF is input to the inverting input terminal (−) of the reset signal generation circuit 16. The reset signal generation circuit 16 generates a reset signal SR according to the result of comparison between the feedback voltage Vf and the comparison voltage REF.

Specifically, when the feedback voltage Vf is lower than the comparison voltage REF, the reset signal generation circuit 16 keeps the reset signal SR at a low level. Conversely, when the feedback voltage Vf is higher than the comparison voltage REF, the reset signal generation circuit 16 keeps the reset signal SR at a high level.

The first reference voltage generation circuit 21 generates a first reference voltage Vr1. The first reference voltage Vr1 is a predetermined constant voltage.

The oscillation circuit 19 generates a reference clock signal CLKa on the basis of the first reference voltage Vr1, and inputs the reference clock signal CLKa to the driver stage 1B (more specifically, a logic circuit 14 to be described later). The reference clock signal CLKa is a pulse signal that rises from a low level to a high level at a predetermined oscillation frequency. A detailed configuration of the oscillation circuit 19 will be described later. Hereinafter, the oscillation frequency of the reference clock signal CLKa is also referred to as simply a “pulse frequency.”

The driver stage 1B generates the drive signals G1 and G2 on the basis of input of the reference clock signal CLKa and the reset signal SR and executes the switching driving of the switch output stage HB. More specifically, the switching driving is executed as follows.

When detecting a rise of the reference clock signal CLKa, the driver stage 1B sets the drive signal G1 to a high level and sets the drive signal G2 to a low level to turn on the output element N1 and turn off the rectifier element N2. Further, when detecting a rise of the reset signal SR, the driver stage 1B sets the drive signal G1 to the low level and sets the drive signal G2 to the high level to turn off the output element N1 and turn on the rectifier element N2.

A specific configuration of the driver stage 1B is as follows. The driver stage 1B includes the logic circuit 14 and a signal generation circuit 15.

The logic circuit 14 is an RS flip-flop including a set input terminal SET, a reset input terminal RST, and an output terminal Q. The set input terminal SET is connected to the oscillation circuit 19. The reset input terminal RST is connected to an output terminal of the reset signal generation circuit 16. The output terminal Q is connected to the signal generation circuit 15.

The reference clock signal CLKa is input from the oscillation circuit 19 to the set input terminal SET. The reset signal is input from the reset signal generation circuit 16 to the reset input terminal RST. The output terminal Q inputs a first pulse width modulation (PWM) signal SP1 to the signal generation circuit 15.

The logic circuit 14 generates the PWM signal SP1 on the basis of the reference clock signal CLKa and the reset signal. When detecting a rising edge of the reference clock signal CLKa to the high level through the set input terminal SET, the logic circuit 14 raises the logic level of the PWM signal SP1 to a high level. Moreover, when detecting a rising edge of the reset signal to the high level through the reset input terminal RST, the logic circuit 14 lowers the logic level of the PWM signal SP1 to a low level.

The signal generation circuit 15 generates the drive signals G1 and G2 on the basis of the PWM signal SP1. Specifically, when the PWM signal SP1 is at the high level, the signal generation circuit 15 sets the logic level of the drive signal G1 to the high level and sets the logic level of the drive signal G2 to the low level. Conversely, when the PWM signal SP1 is at the low level, the signal generation circuit 15 sets the logic level of the drive signal G1 to the low level and sets the logic level of the drive signal G2 to the high level.

### <Switching Operation of Switch Output Stage HB>

As described above, when a rising edge of the reference clock signal CLKa is detected, the PWM signal SP1 rises to the high level. Further, as described above, when the PWM signal SP1 rises to the high level, the drive signal G1 rises to the high level, and the drive signal G2 falls to the low level. At this time, the output element N1 is turned on, and the rectifier element N2 is turned off. Then, the switch voltage Vsw rises from a low level (=GND) to a high level (≈Vin).

As a result, an inductor current IL shifts from decrease to increase. In response to this shift, a charge corresponding to the inductor current IL is accumulated in the capacitor C1, and the first output voltage Vo1 starts to rise.

Thereafter, when the feedback voltage Vf exceeds the comparison voltage REF, the reset signal SR rises to the high level. Then, the PWM signal SP1 falls to the low level. Accordingly, the drive signal G1 falls to the low level, and the drive signal G2 rises to the high level. Then, the output element N1 is turned off, and the rectifier element N2 is turned on.

As a result, the inductor current IL shifts from increase to decrease. Moreover, at this time, the charge of the capacitor C1 is discharged to the ground terminal GND, and thus, the first output voltage Vo1 rapidly lowers to the ground voltage GND (=0 V). Accordingly, the reset signal SR falls to the low level without delay. Further, the switch voltage Vsw falls from the high level (≈Vin) to the low level (≈GND). From then on, similar operation as described above is repeated.

The semiconductor device 40 generates the second output voltage Vo2 on the basis of the first reference voltage Vr1, the reference clock signal CLKa, and the second external resistor R6. Details of the semiconductor device 40 are as follows.

The semiconductor device 40 includes a first signal generation circuit 41, a second signal generation circuit 42, a count circuit 43, and a decoder 44.

The first signal generation circuit 41 generates a first clock signal CLKb on the basis of the first reference voltage Vr1 and the reference clock signal CLKa. The second signal generation circuit 42 generates a second clock signal CLKc on the basis of the first reference voltage Vr1 and the reference clock signal CLKa.

The first clock signal CLKb and the second clock signal CLKc are input to the count circuit 43. The count circuit 43 generates a count signal Sc on the basis of the first clock signal CLKb and the second clock signal CLKc.

The decoder 44 receives input of the count signal Sc. The decoder 44 generates the second output voltage Vo2 on the basis of the count signal Sc. Details of the semiconductor device 40 will be described later.

### <Configuration of Oscillation Circuit 19>

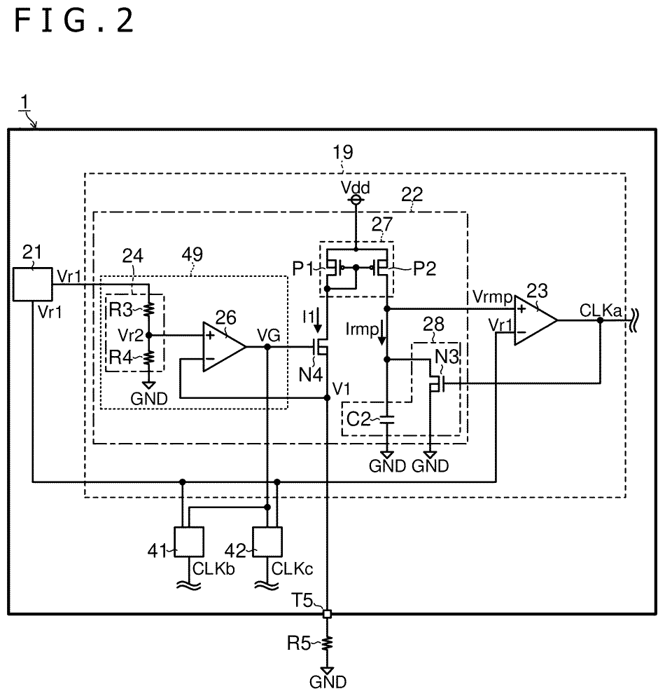

Next, a detailed configuration of the oscillation circuit 19 is described. FIG. 2 is a diagram depicting the configuration of the oscillation circuit 19. The oscillation circuit 19 includes a ramp voltage generation circuit 22 and a comparator 23.

The ramp voltage generation circuit 22 generates a ramp voltage Vrmp on the basis of the first reference voltage Vr1. The ramp voltage Vrmp alternately repeats rise and fall with a predetermined saw wave shape. Details of the ramp voltage generation circuit 22 and the ramp voltage Vrmp will be described later.

The ramp voltage Vrmp is input to a first input terminal of the comparator 23. Further, the first reference voltage Vr1 is input to a second input terminal of the comparator 23. The comparator 23 outputs the reference clock signal CLKa as the result of comparison between the ramp voltage Vrmp and the first reference voltage Vr1.

### <Ramp Voltage Generation Circuit 22 and Ramp Voltage Vrmp>

The ramp voltage generation circuit 22 includes a drive voltage generation circuit 49, a switch element N4, a current mirror circuit 27, and a current-voltage conversion circuit 28.

The drive voltage generation circuit 49 generates a drive voltage VG on the basis of the first reference voltage Vr1. The drive voltage generation circuit 49 includes a voltage divider circuit 24 and an operational amplifier 26.

The voltage divider circuit 24 includes a resistor R3 and a resistor R4. A first end of the resistor R3 receives input of the first reference voltage Vr1. A second end of the resistor R3 is connected to a first end of the resistor R4. A second end of the resistor R4 is connected to the ground terminal GND.

A divided voltage Vr2 is generated at a connection node between the resistor R3 and the resistor R4. The divided voltage Vr2 is a voltage obtained by dividing the first reference voltage Vr1 and the ground voltage GND by the resistor R3 and the resistor R4.

The operational amplifier 26 includes a non-inverting input terminal (+), an inverting input terminal (−), and an output terminal. The non-inverting input terminal (+) of the operational amplifier 26 is connected to the connection node between the resistor R3 and the resistor R4. That is, the non-inverting input terminal (+) of the operational amplifier 26 receives input of the divided voltage Vr2. Feedback input is made from the output terminal of the operational amplifier 26 to the inverting input terminal (−) thereof through the switch element N4. A node voltage V1 to be described later is input as the feedback input to the inverting input terminal (−).

Further, the output terminal of the operational amplifier 26 is also connected to the first signal generation circuit 41 and the second signal generation circuit 42.

The switch element N4 is an N-channel MOSFET. The output terminal of the operational amplifier 26 is connected to a gate terminal of the switch element N4. A drain terminal of the switch element N4 is connected to the current mirror circuit 27 (more specifically, a drain terminal of a switch element P1 to be described later). A source terminal of the switch element N4 is connected to the external terminal T5 together with the inverting input terminal (−) of the operational amplifier 26. The node voltage V1 is generated at a connection node between the external terminal T5 and the source terminal of the switch element N4.

The node voltage V1 (=voltage across the first external resistor R5) changes depending on the gate voltage of the switch element N4 (=output voltage of the operational amplifier 26). More specifically, the operational amplifier 26 generates the drive voltage VG such that the divided voltage Vr2 corresponds to the node voltage V1 (imaginary short), by the feedback input of the node voltage V1, to execute driving control of the switch element N4. Accordingly, a current I1 corresponding to the ground voltage GND and a resistance value of the first external resistor R5 is generated.

The current mirror circuit 27 generates a ramp current Irmp as a mirror current obtained by mirroring the current I1. Specifically, the current mirror circuit 27 is configured as follows.

The current mirror circuit 27 includes the switch elements P1 and P2. The switch elements P1 and P2 are both P-channel MOSFETs. A source terminal of the switch element P1 is connected to an output terminal of a supply voltage Vdd together with a source terminal of the switch element P2. The drain terminal of the switch element P1 is connected to the drain terminal of the switch element N4 together with a gate terminal of the switch element P1 and a gate terminal of the switch element P2.

A drain voltage corresponding to the current I1 is generated at the drain terminal of the switch element N4. This drain voltage is input to the gate terminal of each of the switch elements P1 and P2. Accordingly, the current I1 based on the supply voltage Vdd and the ramp current Irmp corresponding to the current I1 flow.

The current-voltage conversion circuit 28 executes current-voltage conversion of the ramp current Irmp to generate the ramp voltage Vrmp. Specifically, the current-voltage conversion circuit 28 is configured as follows. The current-voltage conversion circuit 28 includes a capacitor C2 and a switch element N3.

A first end of the capacitor C2 is connected to the first input terminal of the comparator 23 together with a drain terminal of the switch element P2. A second end of the capacitor C2 is connected to the ground terminal GND.

A drain voltage corresponding to the ramp current Irmp is generated at the drain terminal of the switch element P2. The capacitor C2 receives this drain input voltage at its own first end and generates the ramp voltage Vrmp obtained by smoothing this drain voltage.

The switch element N3 is an N-channel MOSFET. A gate terminal of the switch element N3 is connected to an output terminal of the comparator 23. A drain terminal of the switch element N3 is connected to the drain terminal of the switch element P2 together with the capacitor C2. A source terminal of the switch element N3 is connected to the ground terminal GND.

The switch element N3 receives input of the reference clock signal CLKa at its own gate terminal. The switch element N3 changes between a saturated state (on-state) and a cutoff state (off-state) according to the reference clock signal CLKa.

For example, when the reference clock signal CLKa is at the high level, the switch element N3 becomes the saturated state. At this time, a channel is formed between the drain terminal and the source terminal of the switch element N3, and a current path is formed. That is, when the reference clock signal CLKa rises to the high level, the ramp current Irmp flows to the ground terminal GND via the switch elements P2 and N3. At this time, a charge of the capacitor C2 is sharply discharged. Thus, the ramp voltage Vrmp sharply drops simultaneously with the rise of the reference clock signal CLKa.

Conversely, when the reference clock signal CLKa is at the low level (is lower than a turn-on threshold voltage of the switch element N3), the switch element N3 becomes the cutoff state. At this time, the channel between the drain terminal and the source terminal of the switch element N3 disappears, and the current path disappears. That is, when the reference clock signal CLKa falls to the low level, the ramp current Irmp flows to the ground terminal GND via the switch element P2 and the capacitor C2. At this time, a charge is gradually accumulated in the capacitor C2. Thus, the ramp voltage Vrmp rises with a predetermined slew rate when the reference clock signal CLKa is at the low level.

<Consideration concerning Function Selection>

Incidentally, in recent years, size reduction of the semiconductor IC device has been advanced with miniaturization in semiconductor manufacturing processes, size reduction of silicon chips accompanying the miniaturization, and progress in wireless technologies for a flip chip quad flat no-lead (FCQFN) package and other packages, for example. This limits the number of PINS (=the number of external terminals) also in an IC chip on which the above-described power supply device 1 is to be mounted. Following such a limit on the number of PINS, the number of functions of the IC chip is also limited.

In order to deal with such a problem, the power supply device 1 according to the embodiment of the present disclosure is configured to be capable of switching a plurality of functions. A configuration relating to the function selection is described in detail below.

### <Semiconductor Device 40>

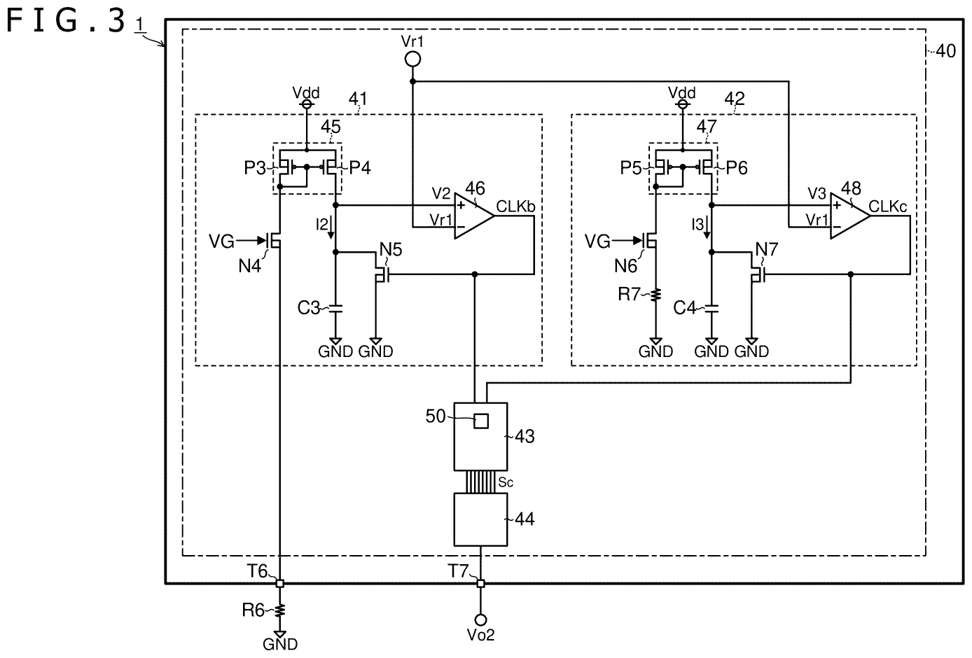

First, a configuration of the semiconductor device 40 is described in detail. FIG. 3 is a block diagram depicting the configuration of the semiconductor device 40. As depicted in FIG. 3, the first signal generation circuit 41 includes switch elements N4 and N5, a current mirror circuit 45, a comparator 46, and an internal capacitor C3.

The switch element N4 is an N-channel MOSFET. A gate terminal of the switch element N4 receives input of the drive voltage VG. A source terminal of the switch element N4 is connected to the external terminal T6. A drain terminal of the switch element N4 is connected to the current mirror circuit 45 (more specifically, a drain terminal of a switch element P3 to be described later).

The current mirror circuit 45 includes the switch elements P3 and P4. The switch elements P3 and P4 are P-channel MOSFETs. The drain terminal of the switch element P3 is connected to a gate terminal of the switch element P3 and a gate terminal of the switch element P4 together with the drain terminal of the switch element N4. A source terminal of the switch element P3 is connected to an application terminal of the supply voltage Vdd together with a source terminal of the switch element P4. A drain terminal of the switch element P4 is connected to a first end of the internal capacitor C3. A second end of the internal capacitor C3 is connected to the ground terminal GND.

The drive voltage VG is input to the gate terminal of the switch element N4, and driving control of the switch element N4 is thus executed. That is, the degree of conduction of the switch element N4 (formation state of a channel in the switch element N4) changes depending on the drive voltage VG. In other words, the voltage of the drain terminal of the switch element N4 changes depending on the drive voltage VG. This changes the voltage to be input to the gate terminals of the switch elements P3 and P4. The switch element P3 shifts from an off-state to a saturated state, and thus, a current flows from the supply voltage Vdd to the ground terminal GND via the switch element N4, the external terminal T6, and the second external resistor R6. The magnitude of this current changes depending on the voltage value of the drive voltage VG. At this time, a mirror current I2 obtained by mirroring this current flows to the internal capacitor C3 via the switch element P4. The internal capacitor C3 is charged by the mirror current I2. Accordingly, a second comparison voltage V2 corresponding to the charge amount of the internal capacitor C3 is generated at a connection node between the switch element P4 and the internal capacitor C3.

The switch element N5 is an N-channel MOSFET. A drain terminal of the switch element N5 is connected to an inverting input terminal (−) of the comparator 46 together with the first end of the internal capacitor C3. A gate terminal of the switch element N5 is connected to an output terminal of the comparator 46. A source terminal of the switch element N5 is connected to the ground terminal GND.

Driving control of the switch element N5 between a saturated state (on-state) and a cutoff state (off-state) is executed according to the output of the comparator 46 which is input to the gate terminal of the switch element N5 (more specifically, according to the first clock signal CLKb).

The switch element N5 receives input of the first clock signal CLKb at its own gate terminal. The switch element N5 changes depending on the first clock signal CLKb. Specifically, the switch element N5 changes as follows.

For example, when the first clock signal CLKb is at a high level, the switch element N5 becomes the saturated state. At this time, a channel is formed between the drain terminal and the source terminal of the switch element N5, and a current path is formed. That is, when the first clock signal CLKb rises to the high level, the mirror current I2 flows to the ground terminal GND via the switch elements P4 and N5. At this time, a charge of the internal capacitor C3 is sharply discharged. Thus, the second comparison voltage V2 sharply drops simultaneously with the rise of the first clock signal CLKb.

A non-inverting input terminal (+) of the comparator 46 receives input of the first reference voltage Vr1. The comparator 46 generates the first clock signal CLKb according to a difference voltage between the voltage of the non-inverting input terminal (+) (=first reference voltage Vr1) and the voltage of the inverting input terminal (−) (=second comparison voltage V2).

The second signal generation circuit 42 includes switch elements N6 and N7, a current mirror circuit 47, a comparator 48, and an internal capacitor C4.

The switch element N6 is an N-channel MOSFET. A gate terminal of the switch element N6 receives input of the drive voltage VG. A source terminal of the switch element N6 is connected to a first end of an internal resistor R7. A drain terminal of the switch element N6 is connected to the current mirror circuit 47 (more specifically, a drain terminal of a switch element P5 to be described later). A second end of the internal resistor R7 is connected to the ground terminal GND.

The current mirror circuit 47 includes the switch elements P5 and P6. The switch elements P5 and P6 are P-channel MOSFETs. The drain terminal of the switch element P5 is connected to a gate terminal of the switch element P5 and a gate terminal of the switch element P6 together with the drain terminal of the switch element N6. A source terminal of the switch element P5 is connected to the application terminal of the supply voltage Vdd together with a source terminal of the switch element P6. A drain terminal of the switch element P6 is connected to a first end of the internal capacitor C4. A second end of the internal capacitor C4 is connected to the ground terminal GND.

The drive voltage VG is input to the gate terminal of the switch element N6, and driving control of the switch element N6 is thus executed. That is, the degree of conduction of the switch element N6 (formation state of a channel in the switch element N6) changes depending on the drive voltage VG. In other words, the voltage of the drain terminal of the switch element N6 changes depending on the drive voltage VG. This changes the voltage to be input to the gate terminals of the switch elements P5 and P6. The switch element P5 shifts from an off-state to a saturated state, and thus, a current flows from the supply voltage Vdd to the ground terminal GND via the switch element N6 and the internal resistor R7. The magnitude of this current changes depending on the voltage value of the drive voltage VG. At this time, a mirror current I3 obtained by mirroring this current flows to the internal capacitor C4 via the switch element P6. The internal capacitor C4 is charged by the mirror current I3. Accordingly, a third comparison voltage V3 corresponding to the charge amount of the internal capacitor C4 is generated at a connection node between the switch element P6 and the internal capacitor C4.

The switch element N7 is an N-channel MOSFET. A drain terminal of the switch element N7 is connected to an inverting input terminal (−) of the comparator 48 together with the first end of the internal capacitor C4. A gate terminal of the switch element N7 is connected to an output terminal of the comparator 48. A source terminal of the switch element N7 is connected to the ground terminal GND.

Driving control of the switch element N7 between a saturated state (on-state) and a cutoff state (off-state) is executed according to the output of the comparator 48 which is input to the gate terminal of the switch element N7 (more specifically, according to the second clock signal CLKc).

The switch element N7 receives input of the second clock signal CLKc at its own gate terminal. The switch element N7 changes depending on the second clock signal CLKc. Specifically, the switch element N7 changes as follows.

For example, when the second clock signal CLKc is at a high level, the switch element N7 becomes the saturated state. At this time, a channel is formed between the drain terminal and the source terminal of the switch element N7, and a current path is formed. That is, when the second clock signal CLKc rises to the high level, the mirror current I3 flows to the ground terminal GND via the switch elements P6 and N7. At this time, a charge of the internal capacitor C4 is sharply discharged. Thus, the third comparison voltage V3 sharply drops simultaneously with the rise of the second clock signal CLKc.

A non-inverting input terminal (+) of the comparator 48 receives input of the first reference voltage Vr1. The comparator 48 generates the second clock signal CLKc according to a difference voltage between the voltage of the non-inverting input terminal (+) (=first reference voltage Vr1) and the voltage of the inverting input terminal (−) (=third comparison voltage V3).

The count circuit 43 receives input of the first clock signal CLKb and the second clock signal CLKc. The count circuit 43 generates the count signal Sc on the basis of the first clock signal CLKb and the second clock signal CLKc. The count signal Sc is a digital signal having a bit value of multiple bits (here, 8 bits).

The decoder 44 receives input of the count signal Sc. The decoder 44 generates the second output voltage Vo2 according to the bit value of the count signal Sc.

### <Count Circuit 43>

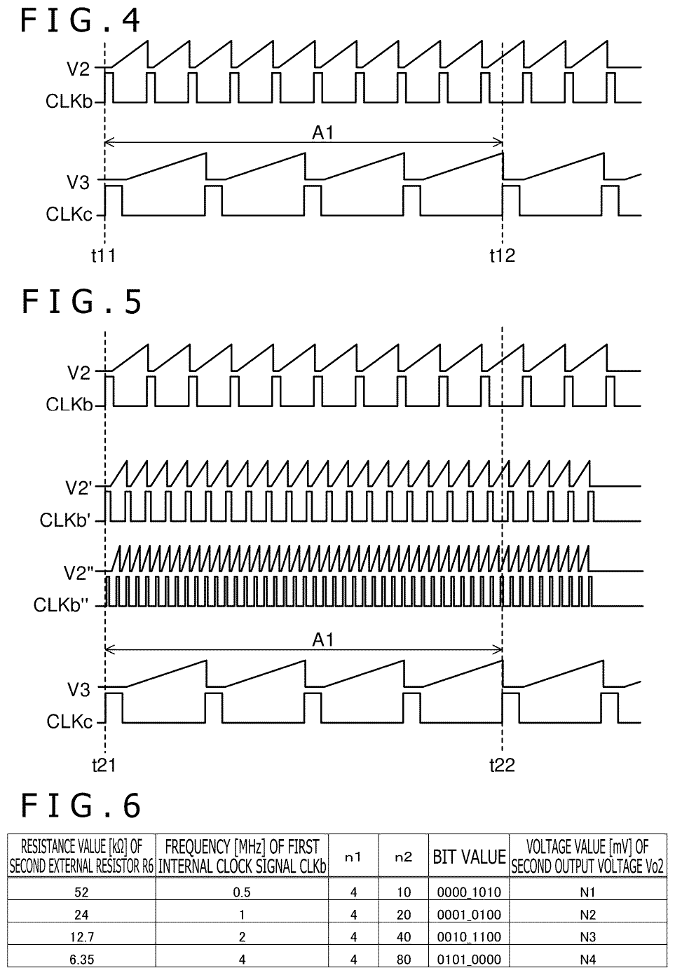

Next, the count circuit 43 is described in more detail. FIG. 4 is a timing chart depicting pulses of the first clock signal CLKb and the second clock signal CLKc. In FIG. 4, the second comparison voltage V2, the first clock signal CLKb, the third comparison voltage V3, and the second clock signal CLKc are depicted in order from the top.

As depicted in FIG. 4, the count circuit 43 detects a determination section A1 on the basis of the second clock signal CLKc. The determination section A1 is a predetermined time interval. The count circuit 43 detects pulse edges (e.g., rising edges) of the second clock signal CLKc and counts the pulse edges as a count value n1.

The count circuit 43 resets the count value n1 to zero when the count value n1 has become predetermined M. M is a natural number equal to or larger than 1 and is set in advance. In the example depicted in FIG. 4, M is set as 4. The count circuit 43 detects, as the determination section A1, a period from a timing at which the count value n1 is reset to zero (in a case of FIG. 4, time t11) to a timing at which the count value n1 reaches M (in the case of FIG. 4, time t12).

Further, while detecting the determination section A1 as described above, the count circuit 43 counts, as a count value n2, pulse edges (e.g., rising edges) of the first clock signal CLKb generated during the determination section A1. The count circuit 43 internally has a storage area 50 such as a register (see FIG. 3). The count circuit 43 stores the count value n2 in the storage area 50.

The count circuit 43 updates the count value n2 in the storage area 50 every time the count circuit 43 detects the pulse edge of the second clock signal CLKc. Then, at the end of the determination section A1 (in the case of FIG. 4, time t12), the count circuit 43 generates the count signal Sc on the basis of the count value n2 stored in the storage area 50. Then, the count circuit 43 resets the count value n2 stored in the storage area 50 to zero. The count signal Sc is a signal obtained by converting the count value n2 to any number of bits (here, 8 bits).

After storing the count value n2 in the determination section A1 in the storage area 50, the count circuit 43 does not count the count value n2 in the next determination section A1 but generates the count signal Sc on the basis of the count value n2 stored in the storage area 50.

### <Second External Resistor R6 and First Clock Signal CLKb>

As described above, the first signal generation circuit 41 (more specifically, the source terminal of the switch element N4) is connected to the second external resistor R6. That is, the mirror current I2 and hence the second comparison voltage V2 change depending on a resistance value of the second external resistor R6. The pulse cycle of the first clock signal CLKb also changes in response to the change in the second comparison voltage V2. Specifically, the pulse cycle changes as follows.

FIG. 5 is a timing chart depicting the first clock signal CLKb in a case in which the second external resistor R6 is changed to a resistor with a different resistance value. In FIG. 5, the chart of the second comparison voltage V2 and the first clock signal CLKb corresponds to a state in which the resistance value of the second external resistor R6 is 52 kΩ. Further, in FIG. 5, the second comparison voltage V2 in a state in which the resistance value of the second external resistor R6 is 25 kΩ is represented by a reference sign V2′, and the first clock signal CLKb in this state is represented by a reference sign CLKb′. Moreover, in FIG. 5, the second comparison voltage V2 in a state in which the resistance value of the second external resistor R6 is 12.7 kΩ is represented by a reference sign V2″, and the first clock signal CLKb in this state is represented by a reference sign CLKb″.

As depicted in FIG. 5, the pulse cycle of the first clock signal CLKb″ is shorter than the pulse cycle of each of the first clock signals CLKb and CLKb′. That is, the count value n2 becomes larger as the resistance value of the second external resistor R6 is smaller.

FIG. 6 is a table indicating a relation between the resistance value of the second external resistor R6, the count value n2, and the voltage value of the second output voltage Vo2. As depicted in FIG. 6, the frequency of the first clock signal CLKb changes depending on the resistance value of the second external resistor R6. Accordingly, the count value n2 also changes in such a manner as described above. As described above, the count circuit 43 executes bit conversion (in a case of FIG. 6, 8-bit conversion) for the count value n2 to generate the count signal Sc.

The decoder 44 decodes the count signal Sc to read the count value n2 and changes the voltage value of the second output voltage Vo2 according to the read count value n2. For example, as depicted in FIG. 6, when the count value n2 is 10, the decoder 44 sets the voltage value of the second output voltage Vo2 to N1 mV. Further, for example, when the count value n2 is 20, the decoder 44 sets the voltage value of the second output voltage Vo2 to N2 mV. N1 to N4 indicated in FIG. 6 are any voltage values.

Therefore, a desired function (voltage value of the second output voltage Vo2) can be selected by preparing a plurality of second external resistors R6 with different resistance values at the time of mounting of the second external resistor R6 and selecting and mounting the second external resistor R6 suitable for the desired second output voltage Vo2. That is, it becomes possible to output various voltage values from one external terminal (in a case of FIGS. 1 and 3, the external terminal T7). Thus, it is possible to provide an IC with which a wide variety of functions can be selected and used while the number of PINs is reduced.

### <Variation in Second External Resistor R6>

Next, a relation between variation in the second external resistor R6 and variation in the count value n2 is described. The accuracy of the second external resistor R6 falls within a range of ±5% with respect to a set value of the resistance value. For the internal resistor R7, a temperature characteristic is compensated. That is, the temperature characteristic is resolved for the internal resistor R7, and the internal resistor R7 keeps a constant resistance value against change in the ambient temperature. Therefore, variation in the internal resistor R7 is not considered here.

The frequency of the first clock signal CLKb varies depending on the variation in the second external resistor R6. For example, it is assumed that an error of 5% occurs in the resistance value of the second external resistor R6 with respect to the set value. At this time, an error of 10% occurs in the frequency of the first clock signal CLKb.

Specifically, the error occurs as follows. It is assumed that the second external resistor R6 has a resistance value of 52 kΩ and the resistance value has a variation of 5%. It is assumed that, in this case, the set value of the resistance value of the second external resistor R6 is 52 kΩ. In this case, an error of +5% occurs in the resistance value of the second external resistor R6 with respect to the set value, and the resistance value becomes 54.6 kΩ. Moreover, in this case, an error of +10% occurs in the count value n2 of the first clock signal CLKb, and the count value n2 becomes 11.

Here, as depicted in FIG. 6, the count value n2 is 10 in the ideal state in which variation does not occur in the second external resistor R6. Further, the bit data of the count signal Sc is “0000_1010.” However, in a case in which the above-described variation occurs, the count value n2 becomes 11, and the bit data of the count signal Sc becomes “0000_1011.”

The decoder 44 decides the output value of the second output voltage Vo2 according to the values of bits more significant than the least significant bit of the bit data included in the count signal Sc (more preferably, values from the second significant bit to the fifth significant bit). For example, it is assumed that the bit data of the count signal Sc becomes “0000_1011” due to the variation in the second external resistor R6 as described above. At this time, the values from the second significant bit to the fifth significant bit are “000_1.” The decoder 44 reads this “000_1” and detects that the count value n2 is 10.

Further, for example, it is assumed that the second external resistor R6 has a resistance value of 25.5 kΩ. In this case, the count value n2 in the ideal state in which variation does not occur is 20. Moreover, the intrinsic bit data of the count signal Sc is “0001_0100.” It is assumed that, in this case, an error of +5% occurs in the resistance value of the second external resistor R6. In this case, the resistance value of the second external resistor R6 becomes 25.5 kΩ, and an error of +10% occurs in the count value n2, so that the count value n2 becomes 22. In addition, the bit data of the count signal Sc becomes “0001_0110” and does not correspond to the above-described bit data “0001_0100.”

The decoder 44 refers to the values from the second significant bit to the fifth significant bit of the bit data, that is, “001_0,” and detects that the count value n2 is 20. The same applies to a case in which the resistance value of the second external resistor R6 is 12.7 kΩ and a case in which the resistance value is 6.35 kΩ.

In this way, the decoder 44 refers to the values from the second significant bit to the fifth significant bit. With this, even when variation occurs in the second external resistor R6, erroneous detection of the count value n2 is less likely to occur. Therefore, the output value of the second output voltage Vo2 can properly be set even when variation occurs in the second external resistor R6.

### <Modifications>

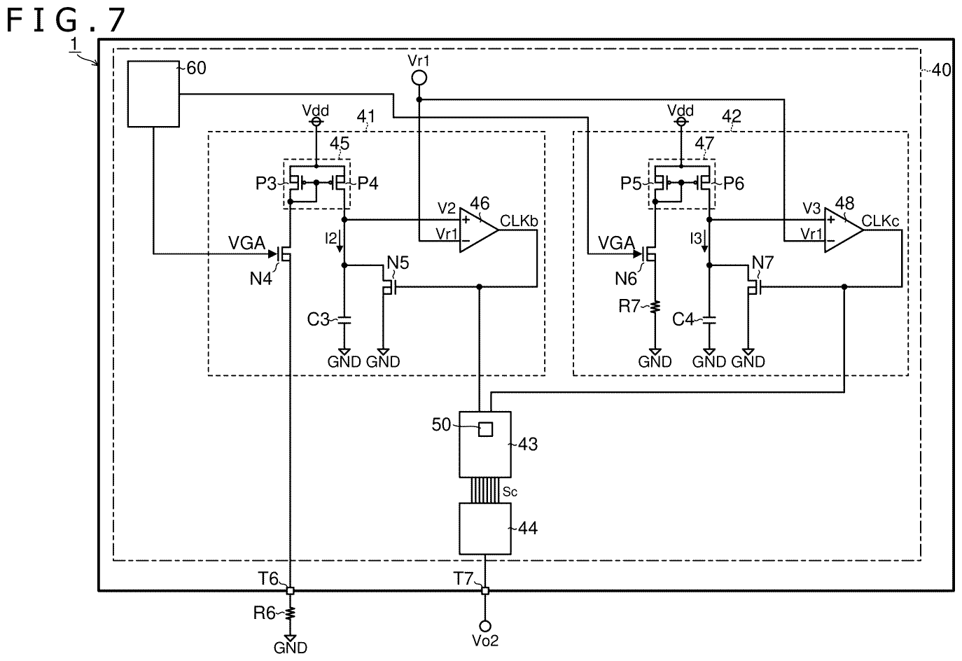

Besides, the present disclosure is not limited to the above-described embodiment, and various changes can be given without departing from the gist of the present disclosure. For example, although the description has been given of the configuration in which the drive voltage VG is input to the gate terminal of each of the switch elements N4 and N6, the configuration is not limited thereto. For example, as depicted in FIG. 7, the semiconductor device 40 can include a drive voltage generation circuit 60 that generates a drive voltage VGA different from the drive voltage VG. In this case, not the drive voltage VG but the drive voltage VGA is input to the gate terminal of each of the switch elements N4 and N6.

Further, although the case of M=4 has been described by way of example in the above-described embodiment, M is not limited to 4. Moreover, in the example described above, the bit data included in the count signal Sc is 8-bit data. However, bit data with a different number of bits other than 8 bits may also be employed.

In addition, although the description has been given of the configuration in which, after the count value n2 is stored in the storage area 50, the count value n2 is not counted in the next determination section A1, the configuration is not limited thereto. For example, the count value n2 may be counted in the next determination section A1, and the count value n2 stored in the storage area 50 may be updated.

### <Supplementary Note>

A semiconductor device (40) disclosed in the specification has a configuration (first configuration) including a drive voltage (VG) generation circuit (49) configured to generate a drive voltage (VG) on the basis of a first external resistor (R5) externally attached to a first external terminal (T5), a first signal generation circuit (41) configured to generate a first clock signal (CLKb) for pulse driving based on the drive voltage (VG) and a second external resistor (R6) externally attached to a second external terminal (T6), a second signal generation circuit (42) configured to generate a second clock signal (CLKc) for pulse driving based on an internal resistor (R7) and the drive voltage (VG), a count circuit (43) configured to generate a count signal (Sc) according to a count value (n2) obtained by counting pulses of the first clock signal (CLKb) in a determination section (A1) while counting the determination section (A1) according to pulses of the second clock signal (CLKc), and a multifunction output circuit (44) configured to output, from a third external terminal (T7), an output signal (Vo2) of an output value that differs depending on the count signal (Sc).

The semiconductor device (40) according to the first configuration may have a configuration (second configuration) in which the internal resistor (R7) is configured such that temperature dependence is compensated.

The semiconductor device (40) according to the first or second configuration may have a configuration (third configuration) in which the count value (n2) is bit data of 8 bits or more.

The semiconductor device (40) according to the third configuration may have a configuration (fourth configuration) in which the count circuit (43) generates the count signal (Sc) according to a value of a bit that is more significant than the least significant bit of the bit data.

The semiconductor device (40) according to the fourth configuration may have a configuration (fifth configuration) in which the count value (n2) is bit data of 8 bits, and the count circuit (43) generates the count signal (Sc) according to values from the second significant bit to the fifth significant bit of the bit data.

A power supply device (1) disclosed in the specification has a configuration (sixth configuration) including the semiconductor device (40) according to any of the first to fifth configurations, an oscillation circuit (19) configured to generate a reference clock signal (CLKa) for pulse driving based on the drive voltage (VG) and the first external resistor (R5), an output stage (HB) configured to generate a switch voltage that is driven between a first logic level and a second logic level with a lower voltage than that of the first logic level, and a driver stage (1B) configured to execute driving control of the output stage (HB) on the basis of the reference clock signal (CLKa).

What is claimed is:

1. A semiconductor device comprising:
a drive voltage generation circuit configured to generate a drive voltage on a basis of a first external resistor externally attached to a first external terminal;
a first signal generation circuit configured to generate a first clock signal for pulse driving based on the drive voltage and a second external resistor externally attached to a second external terminal;
a second signal generation circuit configured to generate a second clock signal for pulse driving based on an internal resistor and the drive voltage;
a count circuit configured to generate a count signal according to a count value obtained by counting pulses of the first clock signal in a determination section while counting the determination section according to pulses of the second clock signal; and
a multifunction output circuit configured to output, from a third external terminal, an output signal of an output value that differs depending on the count signal.

2. The semiconductor device according to claim 1, wherein
the internal resistor is configured such that temperature dependence is compensated.

3. The semiconductor device according to claim 1, wherein
the count value is bit data of 8 bits or more.

4. The semiconductor device according to claim 3, wherein
the count circuit generates the count signal according to a value of a bit that is more significant than a least significant bit of the bit data.

5. The semiconductor device according to claim 4, wherein
the count value is bit data of 8 bits, and
the count circuit generates the count signal according to values from a second significant bit to a fifth significant bit of the bit data.

6. A power supply device comprising:
the semiconductor device according to claim 1;
an oscillation circuit configured to generate a reference clock signal for pulse driving based on the drive voltage and the first external resistor;
an output stage configured to generate a switch voltage that is driven between a first logic level and a second logic level with a lower voltage than that of the first logic level; and
a driver stage configured to execute driving control of the output stage on a basis of the reference clock signal.
